(19) United States
(12) Patent Application Publication
(10) Pub. No.: US 2026/0242695 A1
(43) Pub. Date: Aug. 20, 2026

(54) STABLE ALKYLAMINE COMPOSITIONS

(71) Applicant: Valent U. S. A. LLC, San Ramon, CA (US)

(72) Inventors: Yuki Furukawa, Dublin, CA (US); Saki Matsushita, Osaka (JP); Brian Lin, Fremont, CA (US)

(21) Appl. No.: 19/538,122

(22) Filed: Feb. 12, 2026

Related U.S. Application Data
(60) Provisional application No. 63/759,400, filed on Feb. 17, 2025.

(51) Int. Cl. C11D 1/72

(52) U.S. Cl. CPC C11D 1/72

(57) ABSTRACT

The present invention is directed to compositions comprising one or more alkylamines, one or more emulsifiers and one or more antifoaming agents. The present invention is further directed to compositions comprising an octylamine, decylamine oxide and one or more ethoxylated alcohols comprising an alcohol comprising from 9 to 14 carbon atoms an average of 6 to 23 moles of ethylene oxide. The present invention is further directed to compositions comprising one or more alkylamines and at least about 10% w/w water. The present invention is further directed to methods of eluting or degrading protoporphyrinogen oxidase (“PPO”) inhibitors from agricultural equipment comprising contacting the agricultural equipment with a composition of the present invention.

### FIELD OF THE INVENTION

The present invention is directed to compositions comprising one or more alkylamines, one or more emulsifiers and one or more antifoaming agents. The present invention is further directed to compositions comprising an octylamine, decylamine oxide and one or more ethoxylated alcohols comprising an alcohol comprising from 9 to 14 carbon atoms an average of 6 to 23 moles of ethylene oxide. The present invention is further directed to compositions comprising one or more alkylamines and at least about 10% w/w water. The present invention is further directed to methods of eluting or degrading protoporphyrinogen oxidase inhibitors from agricultural equipment comprising contacting the agricultural equipment with a composition of the present invention.

### BACKGROUND OF THE INVENTION

Protoporphyrinogen oxidase (“PPO”) inhibitors are herbicides that primarily control broadleaf weeds. PPO inhibitors create highly toxic molecules upon contact with the weed that result in destruction of plant tissue. As such, PPO inhibitors are effective herbicides at concentrations as low as 10 grams per hectare (e.g. 72 ppm sprayed at 15 gallons per acre). See Hao et al., Protoporphyrinogen oxidase inhibitor: an ideal target for herbicide discovery, 2011, Chimia, 65 (12) 961-9.

Due to the effectiveness of PPO inhibitors at very low concentrations, growers must thoroughly clean the application equipment after application of PPO inhibitors or else risk harming crops sensitive to PPO inhibitors such as cotton, legumes, Canola, etc., For example, butafenacil, an extremely effective PPO inhibitor and can easily contaminate application equipment by leaving behind a tenacious residue that is challenging to remove. One way to overcome contamination issues when the same application equipment was used for further application of other agricultural products to sensitive crops was the use of dedicated equipment for butafenacil.

Current cleaning practices including physical scrubbing are insufficient to remove residual PPO inhibitor residue from agricultural equipment. In fact, there does not currently exist a method capable of reducing the levels of highly efficacious PPO inhibitors in the application equipment such that residual PPO inhibitors within the equipment does not damage crops when applying subsequent applications to the crops.

Thus, there exists a need in the art for compositions that reduce the levels of PPO inhibitors in agricultural equipment to reduce and/or prevent crop damage upon further use of the equipment.

### SUMMARY OF THE INVENTION

In one aspect, the present invention is directed to compositions comprising one or more alkylamines, one or more emulsifiers and one or more antifoaming agents.

In another aspect, the present invention is directed to compositions comprising an octylamine, decylamine oxide and one or more ethoxylated alcohols comprising an alcohol comprising 14 carbon atoms an average of 6 to 23 moles of ethylene oxide.

In another aspect the present invention is directed to compositions comprising one or more alkylamines and at least about 10% w/w water.

In another aspect, the present invention is directed to methods of eluting protoporphyrinogen oxidase (“PPO”) inhibitors from agricultural equipment comprising contacting the agricultural equipment with an effective amount of a composition of the present invention.

In another aspect, the present invention is directed to methods of degrading PPO inhibitors from agricultural equipment comprising contacting the agricultural equipment with an effective amount of a composition of the present invention.

### DETAILED DESCRIPTION OF THE INVENTION

Compositions that reduce levels of PPO inhibitors in agricultural equipment are likely to be shipped and stored in a concentrated form and diluted by the end-user prior to application. Some alkylamines have a low flashpoint relative to storage and use by farmers. Further, dilution of these alkylamines can lead to foaming issues and poor emulsion stability.

The Applicant has surprisingly discovered that the alkylamine compositions of the present invention achieve good antifoaming properties during dilution, good emulsion stability after dilution and flashpoints that support transport and storage. Specifically, Applicant has found that the addition of emulsifiers, antifoaming agent and/or particular concentrations of water achieve these advantageous results.

In one embodiment, the present invention is directed to a composition comprising one or more alkylamines, one or more emulsifiers and one or more antifoaming agents.

In a preferred embodiment, the one or more alkylamines of the present invention comprise from 6 to 10 carbon atoms. Alkylamines comprising from 6 to 10 carbon atoms include, but are not limited to, hexylamine, heptylamine, octylamine, nonylamine and decylamine.

Emulsifiers suitable for use in the present invention include, but are not limited to, decylamine oxide and ethoxylated alcohols.

In a preferred embodiment, ethoxylated alcohols of the present invention comprise an alcohol comprising from 9 to 14 carbon atoms, more preferably from 9 to 11 carbon atoms or 12 to 14 carbon atoms.

In another preferred embodiment, ethoxylated alcohols of the present invention comprise an average of 6 to 23 moles of ethylene oxide, preferably an average of 6 to 12 moles of ethylene oxide and more preferably an average of 6 moles of ethylene oxide.

Antifoaming agents for use in the present invention include, but are not limited to, a silicone compound, a silicone emulsion, a polyether-modified dimethylsiloxane, a polydimethylsiloxane emulsion, a modified polydimethylsiloxane, a blend of polyether-modified polysiloxane with hydrophobic particles and octamethylcyclotetrasiloxane.

In a preferred embodiment, the present invention is directed to compositions comprising an alkylamine and at least about 10% w/w water, more preferably at least about 12% w/w water, even more preferably at least about 15% w/w water. In an even more preferred embodiment, compositions of the present invention comprise from about 10% to about 50% w/w water, more preferably from about 12% to about 50% w/w water, even more preferably from about 15% to about 50% w/w water, even more preferably from about 15% to about 30% w/w and yet even more preferably from about 15% to about 20% w/w.

In another preferred embodiment, compositions of the present invention further comprise at least about 10% w/w water, more preferably at least about 12% w/w water, even more preferably at least about 15% w/w water. In an even more preferred embodiment, compositions of the present invention comprise from about 10% to about 50% w/w water, more preferably from about 12% to about 50% w/w water, even more preferably from about 15% to about 50% w/w water even more preferably from about 15% to about 30% w/w and yet even more preferably from about 15% to about 20% w/w.

In another preferred embodiment, compositions of the present invention have a flashpoint greater than about 70° C., more preferably greater than about 75° C., even more preferably greater than about 80° C., yet even more preferably greater than about 85° C., yet even more preferably greater than about 90° C. and most preferably greater than about 95° C.

In another preferred embodiment, compositions of the present invention comprise an octylamine, decylamine oxide and one or more ethoxylated alcohols comprising an alcohol comprising from 9 to 14 carbon atoms an average of 6 to 23 moles of ethylene oxide.

In another embodiment, the present invention is directed to methods of eluting PPO inhibitors from agricultural equipment comprising contacting the agricultural equipment with an effective amount of a composition of the present invention.

In a preferred embodiment, the compositions of the present invention are in contact with the agricultural equipment for at least about 1 hour, more preferably at least about 2 hours, even more preferably at least about 3 hours, yet even more preferably at least about 4 hours and most preferably at least about 5 hours. In another preferred embodiment, the compositions of the present invention are in contact with the agricultural equipment for about 1 to about 24 hours, more preferably for about 2 to about 18 hours and even more preferably for about 3 to about 10 hours.

In another embodiment, the present invention is directed to methods of degrading PPO inhibitors comprising contacting the PPO inhibitors with an effective amount of a composition of the present invention.

In a preferred embodiment, the PPO inhibitors are in contact with agricultural equipment prior to and during contact with the composition of the present invention.

In another preferred embodiment, the compositions of the present invention are in contact with the PPO inhibitor for at least about 1 hour, more preferably at least about 2 hours, even more preferably at least about 3 hours, yet even more preferably at least about 4 hours and most preferably at least about 5 hours. In another preferred embodiment, the compositions of the present invention are in contact with the PPO inhibitor for about 1 to about 24 hours, more preferably for about 2 to about 18 hours and even more preferably for about 3 to about 10 hours.

In a preferred embodiment, the agricultural equipment of the present invention comprises a hose or a line.

In another preferred embodiment, the agricultural equipment of the present invention comprises one or more materials selected from the group consisting of natural rubber, synthetic rubber, synthetic plastic polymers, polyurethane blends and polyethylene blends. In a more preferred embodiment, the agricultural equipment of the present invention is natural rubber or synthetic rubber.

As used herein the term “amine” refers to a compound comprising a nitrogen atom with a lone pair of electrons, wherein the nitrogen atom is chemically bound to at least three atoms wherein at least one of those three atoms is not hydrogen. Amines suitable for use in the present invention include, but are not limited to alkylamines. As used herein the term “alkylamine” refers to an amine wherein the nitrogen atom is bound to at least one alkyl substituent.

As used herein the term “alkyl” refers to a straight or branched chain alkane radical (i.e. a group missing one of the hydrogen atoms required for a stable structure), (—CₙH₂ₙ₊₁). Examples of alkyls include methyl, ethyl, propyl, iso-propyl, butyl, sec-butyl, pentyl, hexyl, heptyl, octyl, nonyl, decyl, undecyl, dodecyl and isomers thereof.

As used herein the term “protoporphyrinogen oxidase inhibitor” or “PPO inhibitor” refers, but is not limited to, any compound capable of inhibiting the oxidation of protoporphyrinogen through interaction with the protoporphyrinogen oxidase enzyme, including those compounds not yet discovered or synthesized. Current PPO inhibitors include, but are not limited to: diphenyl ethers such as acifluorfen-sodium, bifenox, chlornitrofen, chlomethoxyfen, ethyoxyfen-ethylfluoroglycofen-ethyl, fomesafen, lactofen and oxyfluorfen; N-phenyl-imides such as cinidon-ethyl, flumiclorac-pentyl, fendioxypyracil, epyrifenacil, trifludimoxazin, tiafenacil, butafenacil, saflufenacil, pentoxazone, fluthiacet-methyl, trifludimoxazin and flumioxazin; N-phenyltriazolinones such as sulfentrazone and carfentrazone-ethyl; N-phenyl-oxadiazolones such as oxadiazon and oxadiargyl; phenylpyrazoles such as fluazolate and pyraflufen-ethyl; N-phenyl-triazolinones such as azafenidin, carfentrazone-ethyl and sulfentrazone; and others such as flufenpyr-ethyl, profluazol, pyraclonil, benzfendizone and thidiazimin.

As used herein the term “effective amount” may refer to the amount of the composition or alkylamines that will elute the PPO inhibitors from the agricultural equipment wherein the amount of PPO inhibitors remaining on the agricultural equipment is less than the amount that would cause harm to crops by using the agricultural equipment to apply a subsequent composition to the crops. An appropriate “effective amount” may vary between the type of agricultural equipment, the material contained in the agricultural equipment that comes in contact with the PPO inhibitor and the type of alkylamine contained in the composition of the present invention.

As used herein the term “effective amount” may also refer to the amount of the composition or alkylamines that will degrade the PPO inhibitors wherein the amount of intact PPO inhibitors remaining is less than the amount that would cause harm to crops by applying the remaining intact PPO inhibitors to crops. An appropriate “effective amount” may vary between the type of PPO inhibitor and the type of alkylamine contained in the composition of the present invention.

As used herein the term “degrade” or “degradation” refers to changes in the chemical structure of the PPO inhibitor such that the PPO inhibitor is less effective as an herbicide as compared to the PPO inhibitor that has not changed in chemical structure.

As used herein the term “agricultural equipment” refers to any equipment used in the application of PPO inhibitors to crops or areas in which crops will grow.

The disclosed embodiments are simply exemplary embodiments of the inventive concepts disclosed herein and should not be considered as limiting, unless the claims expressly state otherwise.

As used herein, all numerical values relating to amounts, weight percentages and the like are defined as “about” or “approximately” each particular value, namely, plus or minus 10% (±10%). For example, the phrase “at least 5% by weight” is to be understood as “at least 4.5% to 5.5% by weight.” Therefore, amounts within 10% of the claimed values are encompassed by the scope of the claims.

The articles “a”, “an” and “the” are intended to include the plural as well as the singular, unless the context clearly indicates otherwise.

As used herein the term “one or more” may refer to any number including but not limited to a range of one to infinite, one to one thousand, one to one hundred, one to ten, one to five, one to four, one to three and one to two and one.

The disclosed embodiments are simply exemplary embodiments of the inventive concepts disclosed herein and should not be considered as limiting, unless the claims expressly state otherwise.

The following examples are intended to illustrate the present invention and to teach one of ordinary skill in the art how to use the compositions of the invention. They are not intended to be limiting in any way.

### EXAMPLES

Ammonyx® DO is a decylamine oxide having CAS #2605-79-0. Ammonyx is a registered trademark of and available from Stepan Company. Ammonyx® DO contains about 65% to about 75% w/w water.

Ammonyx® LO is a laurylamine oxide having CAS #1643-20-5. Ammonyx® LO contains about 65% to about 75% water.

Ammonyx® MO is a myristyl dimethylamine oxide having CAS #3332-27-2.

Ammonyx® MO contains about 65% to about 75% water.

Cola® Lux C-8 is an octyldimethylamine oxide having CAS #2605-78-9. Cola® Lux C-8 contains about 30% to about 60% water.

Bio-soft® N91-6, Ethox® 4387, Synperonic® 91/6, and Tergitol® 91/6 are each a C9-C11 ethoxylated alcohol with an average of 6 moles of ethylene oxide having CAS #68439-46-3.

Bio-soft is a registered trademark of and available from Stepan Company. Ethox is a registered trademark of and available from Ethox Chemicals, LLC. Synperonic is a registered trademark of and available from Croda International. Tergitol is a registered trademark of Union Carbide Corp and available from Dow Chemical.

Plurafac® LF 1300 is a proprietary alcohol alkoxylate. Plurafac is a registered trademark of and available from BASF SE.

Tergitol® 15-S-7 is a C12-C14 secondary ethoxylated alcohol with an average of 7 moles of ethylene oxide having CAS #84133-50-6.

Ecosurf® EH-6 is an alcohol ethoxylate having CAS #64366-70-7. Ecosurf is a registered trademark of and available from Dow Chemical Company.

Plurafac® LF 901 is a fatty alcohol alkoxylate.

Plurafac® LF 403 is a proprietary alcohol alkoxylate.

Lutensol® XL 50 is a C10 Guerbet alcohol alkoxylate with an average of 5 moles of ethylene oxide having CAS #166736 Aug. 9. Lutensol is a registered trademark of and available from BASF SE.

Lutensol® XL 50 is a C10 Guerbet alcohol alkoxylate with an average of 7 moles of ethylene oxide having CAS #166736 Aug. 9.

Lutensol® TO 50 is an iso-C13 oxo alcohol ethoxylated with an average of 6 moles of ethylene oxide.

Synperonic® 13/6 is a C13 ethoxylated alcohol with an average of 6 moles of ethylene oxide.

Ethal® DA-4 is a C10 ethoxylated alcohol with an average of 4 moles of ethylene oxide. Ethal is a registered trademark of and available from Ethox Chemicals, LLC.

Ethal® DA-6 is a C10 ethoxylated alcohol with an average of 6 moles of ethylene oxide.

Ethal® DA-9 is a C10 ethoxylated alcohol with an average of 9 moles of ethylene oxide.

Ethal® LA-12 is a C12-C14 ethoxylated alcohol with an average of 12 moles of ethylene oxide.

Ethal® LA-23 is a C12-C14 ethoxylated alcohol with an average of 23 moles of ethylene oxide.

Ethox® 4478 is a C9-C11 ethoxylated alcohol with an average of 2.5 moles of ethylene oxide.

Ethox® 4418 is a C9-C11 ethoxylated alcohol with an average of 8 moles of ethylene oxide.

BYK®-019 is a polyether-modified polydimethylsiloxane. BYK is a registered trademark of and available from BYK-Chemie GMBH.

BYK® 1780 is a blend of polyether-modified polysiloxane with hydrophobic particles.

SAG® 1529 is a modified polydimethylsiloxane. SAG is a registered trademark of and available from Momentive Performance Materials Inc.

SAG® 1572 is a 15% polydimethylsiloxane emulsion.

SAG® 30 is a 30% polydimethylsiloxane emulsion.

SAG® 47 is a modified polydimethylsiloxane.

### Example 1. Emulsifier Selection

### Method

100 milliliters (“ml”) of CIPAC standard water D (342 parts per million) was poured into a 250 ml measuring cylinder and 4.14 grams of each of Compositions 1-26 from Table 1, below, were added. The measuring cylinder was then filled to 200 ml with CIPAC standard water D. The cylinder was then stoppered and inverted 30 times by hand through 180 degrees and then back to its original position within 2 seconds. The cylinder was then placed on the bench for 24 hours at room temperature or 30° C. in a water bath. The cylinder was then measured for percent volume of oil separation, cream and precipitation at 1, 3 and 24 hours. The density of compositions 1-26 is from 0.82 to 0.84. The oil separation is noted in Table 1, below, as a percentage of bottom clear.

TABLE 1

| | | HLB | | | | | | | |
|---|---|---|---|---|---|---|---|---|---|
| Ingredients | Structure | Value | 1 | 2 | 3 | 4 | 5 | 6 | 7 |
| Octylamine | C8 amine | — | 75.6 | 75.6 | 75.6 | 75.6 | 75.6 | 75.6 | 75.6 |
| Ammonyx ® DO | Decylamine oxide | — | 16.0 | 16.0 | 16.0 | 16.0 | 16.0 | 16.0 | 16.0 |
| Synperonic ® 91/6 | C9-C11 ethoxylated | 13.4 | 8.0 | — | — | — | — | — | — |
| | alcohol + 6EO | | | | | | | | |
| Plurafac ® LF | Proprietary alcohol | 2.0 | — | 8.0 | — | — | — | — | — |
| 1300 | alkoxylate | | | | | | | | |
| Tergitol ® 91/6 | C9-C11 ethoxylated | 13.0 | — | — | 8.0 | — | — | — | — |
| | alcohol + 6EO | | | | | | | | |
| Tergitol ® 15-S-7 | C12-C14 ethoxylated | 12.1 | — | — | — | 8.0 | — | — | — |
| | alcohol + 7EO | | | | | | | | |
| Ecosurf ® EH-6 | Alcohol ethoxylate | 10.8 | — | — | — | — | 8.0 | — | — |
| Plurafac ® LF 901 | Fatty alcohol | 10.5 | — | — | — | — | — | 8.0 | — |
| | alkoxylates | | | | | | | | |
| Plurafac ® LF 403 | Proprietary alcohol | 5.0 | — | — | — | — | — | — | 8.0 |
| | alkoxylate | | | | | | | | |
| BYK ®-019 | Polyether-modified | — | 0.4 | 0.4 | 0.4 | 0.4 | 0.4 | 0.4 | 0.4 |
| | polydimethylsiloxane | | | | | | | | |

| | | | | | | | | |
|---|---|---|---|---|---|---|---|---|
| Total (w/w %) | — | 100 | 100 | 100 | 100 | 100 | 100 | 100 |
| Appearance of samples (solution) | — | Clear | Clear | Clear | Clear | Clear | Clear | Clear |
| Emulsion stability (342 ppm, %) | 1 h | A | 28/72 | A | A | 97/3 | A | 30/70 |
| A: no separation | 3 h | A | 27/73 | A | 68/32 | 58/42 | 67/33 | 30/70 |
| Phase separation top/bottom % | 24 h | 95/5 | 27/73 | 95/5 | 63/37 | 54/46 | 63/37 | 30/70 |
| Emulsion Stability Rating (A > B > C) | — | A | C | A | B | B | B | C |

| | | HLB | | | | | | | |
|---|---|---|---|---|---|---|---|---|---|
| Ingredients | Structure | Value | 8 | 9 | 10 | 11 | 12 | 13 | 14 |
| Octylamine | C8 amine | — | 75.6 | 75.6 | 75.6 | 75.6 | 75.6 | 75.6 | 72.1 |
| Ammonyx ® DO | Decylamine oxide | — | 16.0 | 16.0 | 16.0 | 16.0 | 16.0 | 16.0 | 17.0 |
| Lutensol ® XL 50 | C10 Guerbet alcohol | 12.0 | 8.0 | — | — | — | — | — | — |
| | alkoxylate + 5EO | | | | | | | | |
| Lutensol ® XL 70 | C10 Guerbet alcohol | 13.0 | — | 8.0 | — | — | — | — | — |
| | alkoxylate + 7EO | | | | | | | | |
| Lutensol ® TO 50 | iso-C13 oxo alcohol | 11.0 | — | — | 8.0 | — | — | — | — |
| | ethoxylated + 6EO | | | | | | | | |
| Bio-Soft ® N91-6 | C9-C11 ethoxylated | 12.4 | — | — | — | 8.0 | — | — | — |
| | alcohol + 6EO | | | | | | | | |
| Synperonic ® 13/6 | C13 ethoxylated | 11.4 | — | — | — | — | 8.0 | — | — |
| | alcohol + 6EO | | | | | | | | |
| Ethox ® 4387 | C9-C11 ethoxylated | 13.0 | — | — | — | — | — | 8.0 | 5.1 |
| | alcohol + 6EO | | | | | | | | |
| BYK ®-019 | Polyether-modified | — | 0.4 | 0.4 | 0.4 | 0.4 | 0.4 | 0.4 | — |
| | polydimethylsiloxane | | | | | | | | |
| SAG ® 1572 | Poly- | — | — | — | — | — | — | — | 0.7 |
| | dimethylsiloxane | | | | | | | | |
| | emulsion | | | | | | | | |
| BYK ® 1780 | Blend of polyether- | — | — | — | — | — | — | — | 0.5 |
| | modified | | | | | | | | |
| | polysiloxane with | | | | | | | | |
| | hydrophobic particles | | | | | | | | |
| SAG ® 47 | Modified poly- | — | — | — | — | — | — | — | 0.5 |
| | dimethylsiloxane | | | | | | | | |

| | | | | | | | | |
|---|---|---|---|---|---|---|---|---|
| Water | — | — | — | — | — | — | — | 4.1 |
| Total (w/w %) | — | 100.0 | 100.0 | 100.0 | 100.0 | 100.0 | 100.0 | 100.0 |
| Appearance of samples (solution) | — | Clear | Clear | Clear | Clear | Clear | Clear | Turbid |
| Emulsion stability (342 ppm, %) | 1 h | 36/64 | 99/1 | 99/1 | A | 96/4 | A | A |
| A: no separation | 3 h | 35/65 | 64/36 | 62/38 | A | 57/43 | A | 94/6 |
| Phase separation top/bottom % | 24 h | 35/65 | 60/40 | 58/42 | 98/2 | 55/45 | 98/2 | 94/6 |
| Emulsion Stability Rating (A > B > C) | — | C | B | B | A | B | A | A |

| | | HLB | | | | | | |
|---|---|---|---|---|---|---|---|---|
| Ingredients | Structure | Value | 15 | 16 | 17 | 18 | 19 | 20 |
| Octylamine | C8 amine | — | 72.1 | 72.1 | 72.1 | 72.1 | 72.1 | 72.1 |
| Ammonyx ® DO | Decylamine oxide | — | 17.0 | 17.0 | 17.0 | 17.0 | 17.0 | 17.0 |
| Ethal ® DA-4 | C10 ethoxylated | 10.5 | 5.1 | — | — | — | — | — |
| | alcohol + 4EO | | | | | | | |
| Ethal ® DA-6 | C10 ethoxylated | 12.4 | — | 5.1 | — | — | — | — |
| | alcohol + 6EO | | | | | | | |
| Ethal ® DA-9 | C10 ethoxylated | 14.3 | — | — | 5.1 | — | — | — |
| | alcohol + 9EO | | | | | | | |
| Ethal ® LA-12 | C12-C14 ethoxylated | 14.4 | — | — | — | 5.1 | — | — |
| | alcohol + 12EO | | | | | | | |
| Ethox ® 4478 | C9-C11 ethoxylated | — | — | — | — | — | 5.1 | — |
| | alcohol + 2.5EO | | | | | | | |
| Ethox ® 4418 | C9-C11 ethoxylated | 13.8 | — | — | — | — | — | 5.1 |
| | alcohol + 8EO | | | | | | | |
| SAG ® 1572 | Poly- | — | 0.7 | 0.7 | 0.7 | 0.7 | 0.7 | 0.7 |
| | dimethylsiloxane | | | | | | | |
| | emulsion | | | | | | | |
| BYK ® 1780 | Blend of polyether- | — | 0.5 | 0.5 | 0.5 | 0.5 | 0.5 | 0.5 |
| | modified | | | | | | | |
| | polysiloxane with | | | | | | | |
| | hydrophobic particles | | | | | | | |
| SAG ® 47 | Modified poly- | — | 0.5 | 0.5 | 0.5 | 0.5 | 0.5 | 0.5 |
| | dimethylsiloxane | | | | | | | |

| | | | | | | | |
|---|---|---|---|---|---|---|---|
| Water | — | 4.1 | 4.1 | 4.1 | 4.1 | 4.1 | 4.1 |
| Total (w/w %) | — | 100.0 | 100.0 | 100.0 | 100.0 | 100.0 | 100.0 |
| Appearance of samples (solution) | — | Turbid | Turbid | Turbid | Turbid | Turbid | Turbid |
| Emulsion stability (342 ppm, %) | 1 h | 77/23 | 99/1 | A | A | 83/17 | A |
| A: no separation | 3 h | 57/43 | 82/18 | 98/2 | A | 62/38 | A |
| Phase separation top/bottom % | 24 h | 55/45 | 73/27 | 96/4 | A | 58/42 | A |
| Emulsion Stability Rating (A > B > C) | — | C | B | A | A | C | A |

| | | HLB | | | | | | |
|---|---|---|---|---|---|---|---|---|
| Ingredients | Structure | Value | 21 | 22 | 23 | 24 | 25 | 26 |
| Octylamine | C8 amine | — | 68.0 | 71.5 | 70.0 | 70.0 | 70.0 | 70.0 |
| Bio-Soft ® N91-6 | C9-C11 ethoxylated | 12.4 | 20.0 | 16.5 | 16.5 | — | — | — |
| | alcohol + 6EO | | | | | | | |
| Ethox ® 4387 | C9-C11 ethoxylated | 13.0 | — | — | — | 16.5 | — | — |
| | alcohol + 6EO | | | | | | | |
| Ethal ® LA-12 | C12-C14 ethoxylated | 14.4 | — | — | — | — | 16.5 | — |
| | alcohol + 12EO | | | | | | | |
| Ethox ® 4478 | C9-C11 ethoxylated | — | — | — | — | — | — | — |
| | alcohol + 2.5EO | | | | | | | |
| Ethox ® 4418 | C9-C11 ethoxylated | 13.8 | — | — | — | — | — | 16.5 |
| | alcohol + 8EO | | | | | | | |
| BYK ®-019 | Polyether-modified | — | 0.5 | 0.5 | — | — | — | — |
| | polydimethylsiloxane | | | | | | | |
| SAG ® 1572 | Poly- | — | 1.0 | 1.0 | 0.5 | 0.5 | 0.5 | 0.5 |
| | dimethylsiloxane | | | | | | | |
| | emulsion | | | | | | | |
| BYK ® 1780 | Blend of polyether- | — | 0.5 | 0.5 | 0.5 | 0.5 | 0.5 | 0.5 |
| | modified | | | | | | | |
| | polysiloxane with | | | | | | | |
| | hydrophobic particles | | | | | | | |
| SAG ® 47 | Modified poly- | — | | | 0.5 | 0.5 | 0.5 | 0.5 |
| | dimethylsiloxane | | | | | | | |

| | | | | | | | |
|---|---|---|---|---|---|---|---|
| Water | — | 10.0 | 10.0 | 12.0 | 12.0 | 12.0 | 12.0 |
| Total (w/w %) | — | 100.0 | 100.0 | 100.0 | 100.0 | 100.0 | 100.0 |
| Appearance of samples (solution) | — | Turbid | Turbid | Turbid | Turbid | Turbid | Turbid |
| Emulsion stability (342 ppm, %) | 1 h | 95/5 | 70/30 | 67/33 | 65/35 | A | A |
| A: no separation | 3 h | 75/25 | 53/47 | 60/40 | 59/41 | A | 98/2 |
| Phase separation top/bottom % | 24 h | 71/29 | 52/48 | 57/43 | 56/44 | A | 92/8 |
| Emulsion Stability Rating (A > B > C) | — | B | C | C | C | A | A |

“EO” denotes average moles of ethylene oxide.

### Results

As seen in Table 1, above, compositions containing C9-C11 ethoxylated alcohol+6EO, C9-C11 ethoxylated alcohol+8EO, C10 alcohol+9EO and C12-C14 alcohol+12EO provided good emulsion stability.

### Example 2. Antifoam Selection

### Method

20 grams of each of compositions 27-52E were added into glass vials and stored in incubators at 54° C. or 4° C. for 2 weeks. The samples were then evaluated for redispersibility of the compositions, antifoaming properties, and emulsion stability as detailed in Example 1, above. The density of compositions 27-52E is from 0.82 to 0.84. Results can be seen in Table 2, below.

TABLE 2

| Ingredients | Structure | 27 | 28 | 29 | 30 | 31 | 32 | 33 |
|---|---|---|---|---|---|---|---|---|
| Octylamine | C8 amine | 75.60 | 76.0 | 75.2 | 75.6 | 75.15 | 74.48 | 74.86 |
| Ammonyx ® DO | Decylamine oxide | 16.00 | 16.0 | 15.9 | 16.0 | 15.90 | 15.68 | 15.76 |
| Synperonic ® 91/6 | C9-C11 ethoxylated | 8.00 | 8.00 | 7.95 | 8.00 | 7.95 | 7.84 | 7.88 |
| | alcohol + 6EO | | | | | | | |
| BYK ®-019 | Polyether-modified | 0.40 | — | 1.00 | — | — | 1.00 | 1.00 |
| | polydimethylsiloxane | | | | | | | |
| SAG ® 1572 | 15% Poly- | — | — | — | 0.40 | 1.00 | 1.00 | 0.50 |
| | dimethylsiloxane | | | | | | | |
| | antifoam emulsion | | | | | | | |
| BYK ® 1780 | Blend of polyether- | — | — | — | — | — | — | — |
| | modified | | | | | | | |
| | polysiloxane with | | | | | | | |
| | hydrophobic particles | | | | | | | |
| SAG ® 30 | 30% Poly- | — | — | — | — | — | — | — |
| | dimethylsiloxane | | | | | | | |
| | emulsion | | | | | | | |
| SAG ® 47 | Modified poly- | — | — | — | — | — | — | — |
| | dimethylsiloxane | | | | | | | |
| SAG ® 1529 | Modified | — | — | — | — | — | — | — |
| | polydimethylsiloxane | | | | | | | |
| | Total (w/w %) | 100.0 | 100.0 | 100.0 | 100.0 | 100.0 | 100.0 | 100.0 |
| Appearance | Initial | H | H | H | I/H | I/H | I/H | I/H |
| Sedimentation | 54° C. for 2 weeks | H | H | H | H | H | H | H |
| | 4° C. for 2 weeks | H | H | H | I/H | I/H | U/D | U/D |
| Persistent foam (mL, | Initial | 34/15 | 107/50 | 78/30 | 30/26 | 30/22 | 0/0 | 0/0 |
| 342 ppm, 40 times | 54° C. for 2 weeks | 102/41 | No | 93/20 | 102/30 | 112/30 | 68/28 | 98/34 |
| dilution) after 1 | | | data | | | | | |
| min and 12 mins | | | | | | | | |
| Emulsion stability | 1 h | A | A | A | A | A | A | A |
| A: no separation | 3 h | A | A | A | A | A | 97/3 | 95/5 |
| Phase separation | | | | | | | | |
| top/bottom % | | | | | | | | |
| Ingredients | Structure | 34 | 35 | 36 | 37 | 38 | 39 | 40 |
| Octylamine | C8 amine | 74.48 | 73.72 | 74.48 | 73.72 | 75.24 | 73.72 | 75.2 |
| Ammonyx ® DO | Decylamine oxide | 15.68 | 15.52 | 15.68 | 15.52 | 15.84 | 15.52 | 15.9 |
| Synperonic ® 91/6 | C9-C11 ethoxylated | 7.84 | 7.76 | 7.84 | 7.76 | 7.92 | 7.76 | 7.95 |
| | alcohol + 6EO | | | | | | | |
| BYK ®-019 | Polyether-modified | 2.00 | 3.00 | — | — | 0.50 | 1.50 | — |
| | polydimethylsiloxane | | | | | | | |
| SAG ® 1572 | 15% Poly- | — | — | 2.00 | 3.00 | 0.50 | 1.50 | — |
| | dimethylsiloxane | | | | | | | |
| | antifoam emulsion | | | | | | | |
| BYK ® 1780 | Blend of polyether- | — | — | — | — | — | — | 1.00 |
| | modified | | | | | | | |
| | polysiloxane with | | | | | | | |
| | hydrophobic particles | | | | | | | |
| SAG ® 30 | 30% Poly- | — | — | — | — | — | — | — |
| | dimethylsiloxane | | | | | | | |
| | emulsion | | | | | | | |
| SAG ® 47 | Modified poly- | — | — | — | — | — | — | — |
| | dimethylsiloxane | | | | | | | |
| SAG ® 1529 | Modified | — | — | — | — | — | — | — |
| | polydimethylsiloxane | | | | | | | |
| | Total (w/w %) | 100.0 | 100.0 | 100.0 | 100.0 | 100.0 | 100.0 | 100.0 |
| Appearance | Initial | H | H | I/H | I/H | I/H | I/H | D |
| Sedimentation | 54° C. for 2 weeks | H | H | I/H | I/H | H | H | S, R/D |
| | 4° C. for 2 weeks | H | H | S, U/D | S, U/D | S, U/D | S, U/D | — |
| Persistent foam (mL, | Initial | 29/20 | 31/20 | 1/0 | 1/0 | 10/1 | 0/0 | — |
| 342 ppm, 40 times | 54° C. for 2 weeks | 105/63 | 105/45 | 50/35 | 58/28 | 58/40 | 84/58 | 121/37 |
| dilution) after 1 | | | | | | | | |
| min and 12 mins | | | | | | | | |
| Emulsion stability | 1 h | A | A | A | A | A | A | A |
| A: no separation | 3 h | 90/10 | 85/15 | 95/5 | 95/5 | A | 90/10 | A |
| Phase separation | | | | | | | | |
| top/bottom % | | | | | | | | |
| Ingredients | Structure | 41 | 42 | 43 | 44 | 45 | 46 | 47 |
| Octylamine | C8 amine | 75.2 | 74.48 | 74.48 | 74.48 | 74.86 | 74.86 | 74.86 |
| Ammonyx ® DO | Decylamine oxide | 15.9 | 15.68 | 15.68 | 15.68 | 15.76 | 15.76 | 15.76 |
| Synperonic ® 91/6 | C9-C11 ethoxylated | 7.95 | 7.84 | 7.84 | 7.84 | 7.88 | 7.88 | 7.88 |
| | alcohol + 6EO | | | | | | | |
| BYK ®-019 | Polyether-modified | — | — | — | — | — | — | — |
| | polydimethylsiloxane | | | | | | | |
| SAG ® 1572 | 15% Poly- | — | — | — | 1.00 | 1.00 | 0.50 | 0.50 |
| | dimethylsiloxane | | | | | | | |
| | antifoam emulsion | | | | | | | |
| BYK ® 1780 | Blend of polyether- | — | 2.00 | — | 1.00 | 0.50 | 0.50 | 0.50 |
| | modified | | | | | | | |
| | polysiloxane with | | | | | | | |
| | hydrophobic particles | | | | | | | |
| SAG ® 30 | 30% Poly- | 1.00 | — | 2.00 | — | — | 0.50 | — |
| | dimethylsiloxane | | | | | | | |
| | emulsion | | | | | | | |
| SAG ® 47 | Modified poly- | — | — | — | — | — | — | 0.50 |
| | dimethylsiloxane | | | | | | | |
| SAG ® 1529 | Modified | — | — | — | — | — | — | — |
| | polydimethylsiloxane | | | | | | | |
| | Total (w/w %) | 100.0 | 100.0 | 100.0 | 100.0 | 100.0 | 100.0 | 100.0 |
| Appearance | Initial | I/H | D | I/H | D | D | D | D |
| Sedimentation | 54° C. for 2 weeks | S, R/D | S, R/D | S, R/D | S, R/D | S, R/D | S, R/D | S, R/D |
| | 4° C. for 2 weeks | — | — | — | S, R/D | S, R/D | S, R/D | S, R/D |
| Persistent foam (mL, | Initial | — | 0/0 | 0/0 | 0/0 | 0/0 | 0/0 | 0/0 |
| 342 ppm, 40 times | 54° C. for 2 weeks | 38/26 | 121/40 | 23/19 | 88/18 | 54/10 | 25/12 | 20/10 |
| dilution) after 1 | | | | | | | | |
| min and 12 mins | | | | | | | | |
| Emulsion stability | 1 h | — | — | — | A | A | A | A |
| A: no separation | 3 h | — | — | — | B: 4% | A | A | A |
| Phase separation | | | | | | | | |
| top/bottom % | | | | | | | | |

| Ingredients | Structure | 48 | 49 | 50 | 51 | 52 |
|---|---|---|---|---|---|---|
| Octylamine | C8 amine | 74.58 | 74.86 | 75.24 | 74.48 | 75.62 |
| Ammonyx ® DO | Decylamine oxide | 15.68 | 15.76 | 15.84 | 15.68 | 15.92 |
| Synperonic ® 91/6 | C9-C11 ethoxylated | 7.84 | 7.88 | 7.92 | 7.84 | 7.96 |
| | alcohol + 6EO | | | | | |
| BYK ®-019 | Polyether-modified | — | — | — | — | — |
| | polydimethylsiloxane | | | | | |
| SAG ® 1572 | 15% Poly- | 1.00 | 1.00 | — | — | — |
| | dimethylsiloxane | | | | | |
| | antifoam emulsion | | | | | |
| BYK ® 1780 | Blend of polyether- | 0.50 | — | — | — | — |
| | modified | | | | | |
| | polysiloxane with | | | | | |
| | hydrophobic particles | | | | | |
| SAG ® 30 | 30% Poly- | — | — | — | — | — |
| | dimethylsiloxane | | | | | |
| | emulsion | | | | | |
| SAG ® 47 | Modified poly- | 0.50 | 0.50 | 1.00 | 2.00 | 0.50 |
| | dimethylsiloxane | | | | | |
| SAG ® 1529 | Modified | — | — | — | — | — |
| | polydimethylsiloxane | | | | | |
| | Total (w/w %) | 100.0 | 100.0 | 100.0 | 100.0 | 100.0 |
| Appearance | Initial | D | D | S | Miscible, | D |
| Sedimentation | 54° C. for 2 weeks | S, R/D | S, R/D | S, U/D | not | D |
| | 4° C. for 2 weeks | S, R/D | S, R/D | No | redispersible | No |
| | | | | data | | data |
| Persistent foam (mL, | Initial | 0/0 | 0/0 | 14/10 | | 25/12 |
| 342 ppm, 40 times | 54° C. for 2 weeks | 31/16 | 28/20 | 14/8 | | 11/8 |
| dilution) after 1 | | | | | | |
| min and 12 mins | | | | | | |
| Emulsion stability | 1 h | A | A | A | | A |
| A: no separation | 3 h | 95/5 | A | A | | A |
| Phase separation | | | | | | |
| top/bottom % | | | | | | |

| Ingredients | Structure | 52A | 52B | 52C | 52D | 52E |
|---|---|---|---|---|---|---|
| Octylamine | C8 amine | 75.8 | 75.2 | 74.48 | 75.62 | 75.8 |
| Ammonyx ® DO | Decylamine oxide | 16.0 | 15.8 | 15.68 | 15.92 | 16.0 |
| Synperonic ® 91/6 | C9-C11 ethoxylated | 7.98 | 7.92 | 7.84 | 7.96 | 7.98 |
| | alcohol + 6EO | | | | | |
| BYK ®-019 | Polyether-modified | — | — | — | — | — |
| | polydimethylsiloxane | | | | | |
| SAG ® 1572 | 15% Poly- | — | — | — | — | — |
| | dimethylsiloxane | | | | | |
| | antifoam emulsion | | | | | |
| BYK ® 1780 | Blend of polyether- | — | — | — | — | — |
| | modified | | | | | |
| | polysiloxane with | | | | | |
| | hydrophobic particles | | | | | |
| SAG ® 30 | 30% Poly- | — | — | — | — | — |
| | dimethylsiloxane | | | | | |
| | emulsion | | | | | |
| SAG ® 47 | Modified poly- | 0.25 | — | — | — | — |
| | dimethylsiloxane | | | | | |
| SAG ® 1529 | Modified | — | 1.00 | 2.00 | 0.50 | 0.25 |
| | polydimethylsiloxane | | | | | |
| | Total (w/w %) | 100.0 | 100.0 | 100.0 | 100.0 | 100.0 |
| Appearance | Initial | D | S | S | D | D |
| Sedimentation | 54° C. for 2 weeks | S, R/D | S, R/D | S, R/D | S, R/D | S, R/D |
| | 4° C. for 2 weeks | No | No | No | No | No |
| | | data | data | data | data | data |
| Persistent foam (mL, | Initial | 23/18 | 0/0 | 0/0 | 0/0 | 0/0 |
| 342 ppm, 40 times | 54° C. for 2 weeks | 26/16 | 12/8 | 14/6 | 14/10 | 14/8 |
| dilution) after 1 | | | | | | |
| min and 12 mins | | | | | | |
| Emulsion stability | 1 h | A | A | A | A | A |
| A: no separation | 3 h | A | A | A | A | A |
| Phase separation | | | | | | |
| top/bottom % | | | | | | |

“H” denotes homogenous
“I/H” denotes inhomogenous
“D” denotes dispersible
“U/D” denotes undispersible
“R/D” denotes redispersible
“S” denotes sedimentation

### Results

As seen in Table 2, above, compositions containing C9-C11 ethoxylated alcohol+6EO, provided good emulsion stability. Further, compositions containing a silicone-based antifoam agent provided good anti-foam properties.

### Example 3. Preferred Compositions of the Present Invention

### Method

20 grams of each of compositions 53-105 were added into glass vials and stored in incubators at 54° C. for 2 weeks. The samples were then evaluated for redispersibility of the compositions, antifoaming properties, emulsion stability and flashpoint as described in Example 1, above. Flashpoint was measured using an Automated Setaflash ‘Series 7’ Closed-Cup Test. Density of each of compositions 53-81 and 82-103 are 0.83 and 0.87, respectively. Results can be seen in Table 3, below.

TABLE 3

| Ingredients | Structure | 53 | 54 | 55 | 56 | 57 | 58 | 59 |
|---|---|---|---|---|---|---|---|---|
| Octylamine | C8 amine | 72.1 | 72.1 | 72.1 | 71.7 | 72.1 | 72.1 | 72.1 |
| Ammonyx ® DO | Decylamine oxide | 18.0 | 18.0 | 17.0 | 16.3 | 18.0 | 18.0 | 18.0 |
| Bio-Soft ® N91-6 | C9-C11 ethoxylated | 4.80 | — | — | — | — | — | — |
| | alcohol + 6EO | | | | | | | |
| Ethox ® 4387 | C9-C11 ethoxylated | — | 4.80 | 5.10 | 5.70 | 4.80 | 4.80 | 4.80 |
| | alcohol + 6EO | | | | | | | |
| SAG ® 1572 | 15% Poly- | 0.70 | 0.70 | 0.70 | 0.70 | 0.50 | 0.25 | — |
| | dimethylsiloxane | | | | | | | |
| | antifoam emulsion | | | | | | | |
| BYK ® 1780 | Blend of polyether- | 0.50 | 0.50 | 0.50 | 0.50 | 0.50 | 0.50 | 0.50 |
| | modified | | | | | | | |
| | polysiloxane with | | | | | | | |
| | hydrophobic particles | | | | | | | |
| SAG ® 47 | Modified poly- | 0.50 | 0.50 | 0.50 | 0.50 | 0.50 | 0.50 | 0.50 |
| | dimethylsiloxane | | | | | | | |
| Water | Water | 3.40 | 3.40 | 4.10 | 4.60 | 3.60 | 3.85 | 4.10 |
| Total (w/w %) | Total (w/w %) | 100.0 | 100.0 | 100.0 | 100.0 | 100.0 | 100.0 | 100.0 |
| Flashpoint | | >95° C. | >95° C. | >95° C. | >95° C. | >95° C. | >95° C. | >95° C. |
| Water content calculated (%) | | 16.0 | 16.0 | 16.0 | 16.0 | 16.2 | 16.5 | 16.7 |
| Persistent foam | Initial | 0/0 | 0/0 | 0/0 | 0/0 | 0/0 | 0/0 | 0/0 |
| after 1 min and | 54° C. for 2 weeks | 19/13 | 17/15 | 19/15 | 18/17 | 34/18 | 32/14 | 26/14 |
| 12 min (1/12) | | | | | | | | |
| Emulsion stability | 1 hour | A | A | A | A | A | A | A |
| Room Temp. | 3 hours | A | A | 97/3 | 97/3 | A | A | A |
| A: no separation | | | | | | | | |
| Phase separation | | | | | | | | |
| top/bottom % | | | | | | | | |
| Emulsion stability | 1 hour | — | — | — | — | — | — | 35/65 |
| 30° C | 3 hours | — | — | — | — | — | — | 35/65 |
| A: no separation | | | | | | | | |
| Phase separation | | | | | | | | |
| top/bottom % | | | | | | | | |
| Emulsion stability result (A > B) | | A | A | A | A | A | A | A |
| Cleaning Test | | Good | Good | Good | — | — | — | — |
| Appearance of initial samples | | * | * | * | * | * | * | * |
| *Turbid Solution | | | | | | | | |
| Ingredients | Structure | 60 | 61 | 62 | 63 | 64 | 65 | 66 |
| Octylamine | C8 amine | 72.1 | 72.1 | 70.5 | 72.1 | 70.5 | 70.68 | 70.68 |
| Ammonyx ® DO | Decylamine oxide | 18.0 | 18.0 | 16.0 | 18.0 | 17.0 | 14.88 | 14.88 |
| Bio-Soft ® N91-6 | C9-C11 ethoxylated | — | — | 7.20 | 5.20 | 7.30 | 7.44 | 7.44 |
| | alcohol + 6EO | | | | | | | |
| Ethox ® 4387 | C9-C11 ethoxylated | 4.80 | 4.80 | — | — | — | — | — |
| | alcohol + 6EO | | | | | | | |
| SAG ® 1572 | 15% Poly- | — | — | 0.70 | 0.70 | 0.70 | 1.00 | 1.00 |
| | dimethylsiloxane | | | | | | | |
| | antifoam emulsion | | | | | | | |
| BYK ® 1780 | Blend of polyether- | 0.25 | — | 0.50 | 0.50 | 0.50 | 1.00 | 0.50 |
| | modified | | | | | | | |
| | polysiloxane with | | | | | | | |
| | hydrophobic particles | | | | | | | |
| SAG ® 30 | 30% Poly- | — | — | — | — | — | — | 0.50 |
| | dimethylsiloxane | | | | | | | |
| | emulsion | | | | | | | |
| SAG ® 47 | Modified poly- | 0.50 | 0.50 | 0.50 | 0.50 | 0.50 | — | — |
| | dimethylsiloxane | | | | | | | |
| Water | Water | 4.35 | 4.60 | 4.60 | 3.00 | 3.50 | 5.00 | 5.00 |
| Total (w/w %) | Total (w/w %) | 100.0 | 100.0 | 100.0 | 100.0 | 100.0 | 100.0 | 100.0 |
| Flashpoint | | >95° C. | >95° C. | >95° C. | >95° C. | >95° C. | >95° C. | >95° C. |
| Water content calculated (%) | | 17.0 | 17.2 | 15.8 | 15.6 | 15.4 | 15.4 | 15.4 |
| Persistent foam | Initial | 0/0 | 0/0 | 0/0 | 0/0 | 0/0 | 0/0 | 0/0 |
| after 1 min and | 54° C. for 2 weeks | 20/16 | 16/4 | 21/17 | 36/22 | 17/15 | No | 32/26 |
| 12 min (1/12) | | | | | | | data | |
| Emulsion stability | 1 hour | A | A | A | A | A | 98/2 | 99.5/0.5 |
| Room Temp. | 3 hours | A | A | A | A | A | 84/16 | 88/12 |
| A: no separation | | | | | | | | |
| Phase separation | | | | | | | | |
| top/bottom % | | | | | | | | |
| Emulsion stability | 1 hour | — | — | — | — | — | — | — |
| 30° C | 3 hours | — | — | — | — | — | — | — |
| A: no separation | | | | | | | | |
| Phase separation | | | | | | | | |
| top/bottom % | | | | | | | | |
| Emulsion stability result (A > B) | | A | A | A | A | A | B | B |
| Cleaning Test | | — | — | Good | — | Good | — | — |
| Appearance of initial samples | | * | * | * | * | * | * | * |
| *Turbid Solution | | | | | | | | |
| Ingredients | Structure | 67 | 68 | 69 | 70 | 71 | 72 | 73 |
| Octylamine | C8 amine | 70.68 | 72.1 | 72.1 | 72.1 | 72.1 | 72.1 | 72.1 |
| Ammonyx ® DO | Decylamine oxide | 14.88 | 18.0 | 20.0 | 22.0 | 20.0 | 22.0 | 18.0 |
| Bio-Soft ® N91-6 | C9-C11 ethoxylated | 7.44 | — | — | — | — | — | — |
| | alcohol + 6EO | | | | | | | |
| Ethox ® LA-12 | C12-C14 | — | — | — | — | — | — | 4.80 |
| | alcohol + 12EO | | | | | | | |
| Ethox ® 4387 | C9-C11 ethoxylated | — | — | 3.90 | 3.30 | — | — | — |
| | alcohol + 6EO | | | | | | | |
| Ethox ® 4418 | C9-C11 ethoxylated | — | 4.80 | — | — | 3.90 | 3.30 | — |
| | alcohol + 8EO | | | | | | | |
| BYK ® 1780 | Blend of polyether- | 0.50 | 0.50 | 0.50 | 0.50 | 0.50 | 0.50 | 0.50 |
| | modified | | | | | | | |
| | polysiloxane with | | | | | | | |
| | hydrophobic particles | | | | | | | |
| SAG ® 47 | Modified poly- | 0.50 | 0.50 | 0.50 | 0.50 | 0.50 | 0.50 | 0.50 |
| | dimethylsiloxane | | | | | | | |
| Water | Water | 5.00 | 4.1 | 3.00 | 1.60 | 3.00 | 1.60 | 4.10 |
| Total (w/w %) | Total (w/w %) | 100.0 | 100.0 | 100.0 | 100.0 | 100.0 | 100.0 | 100.0 |
| Flashpoint | | >95° C. | — | — | — | — | — | — |
| Water content calculated (%) | | 15.4 | 16.7 | 17.0 | 17.0 | 17.0 | 17.0 | 16.7 |
| Persistent foam | Initial | 0/0 | — | — | — | — | — | — |
| after 1 min and | 54° C. for 2 weeks | 25/16 | — | — | — | — | — | — |
| 12 min (1/12) | | | | | | | | |
| Emulsion stability | 1 hour | 99/1 | A | A | 99/1 | 98/2 | A | A |
| Room Temp. | 3 hours | 88/12 | A | A | 99/1 | 97/3 | A | A |
| A: no separation | | | | | | | | |
| Phase separation | | | | | | | | |
| top/bottom % | | | | | | | | |
| Emulsion stability | 1 hour | — | 40/60 | 38/62 | 42/58 | 40/60 | 45/55 | 43/57 |
| 30° C | 3 hours | — | 40/60 | 38/62 | 41/59 | 40/60 | 44/56 | — |
| A: no separation | | | | | | | | |
| Phase separation | | | | | | | | |
| top/bottom % | | | | | | | | |

| | | | | | | | |
|---|---|---|---|---|---|---|---|
| Emulsion stability result (A > B) | B | B | B | B | B | B | B |
| Cleaning Test | — | — | — | — | — | — | — |
| Appearance of initial samples | * | * | * | * | * | * | * |
| *Turbid Solution | | | | | | | |

| Ingredients | Structure | 74 | 75 | 76 | 77 | 78 | 79 | 80 |
|---|---|---|---|---|---|---|---|---|
| Octylamine | C8 amine | 72.10 | 72.1 | 72.1 | 73.0 | 73.0 | 73.0 | 73.0 |
| Ammonyx ® DO | Decylamine oxide | — | — | — | 26.0 | 16.0 | 10.0 | — |
| Cola ® Lux C-8 | Octyldimethylamine | — | — | 18.0 | — | 7.50 | 12.0 | 20.0 |
| | oxide | | | | | | | |
| Ammonyx ® LO | Laurylamine oxide | 18.00 | — | — | — | — | — | — |
| Ammonyx ® MO | Myristyl | — | 18.00 | — | — | — | — | — |
| | dimethylamine oxide | | | | | | | |
| Ethox ® 4387 | C9-C11 ethoxylated | 4.80 | 4.80 | 4.80 | — | — | — | — |
| | alcohol + 6EO | | | | | | | |
| BYK ® 1780 | Blend of polyether- | 0.50 | 0.50 | 0.50 | 0.50 | 0.50 | 0.50 | 0.50 |
| | modified | | | | | | | |
| | polysiloxane with | | | | | | | |
| | hydrophobic particles | | | | | | | |
| SAG ® 47 | Modified poly- | 0.50 | 0.50 | 0.50 | 0.50 | 0.50 | 0.50 | 0.50 |
| | dimethylsiloxane | | | | | | | |
| Water | Water | 4.10 | 4.10 | 4.10 | 0.00 | 2.50 | 4.00 | 6.00 |
| Total (w/w %) | Total (w/w %) | 100.0 | 100.0 | 100.0 | 100.0 | 100.0 | 100.0 | 100.0 |
| Flashpoint | | — | — | — | — | — | — | — |
| Water content calculated (%) | | 16.7 | 16.7 | 14.9 | 18.2 | 18.2 | 18.2 | 18 |
| Persistent foam | Initial | — | — | — | — | — | — | — |
| after 1 min and | 54° C. for 2 weeks | — | — | — | — | — | — | — |
| 12 min (1/12) | | | | | | | | |
| Emulsion stability | 1 hour | A | — | 46/54 | A | 96/4 | 74/26 | 40/60 |
| Room Temp. | 3 hours | 83/17 | — | 42/58 | A | 79/21 | 60/40 | 37/63 |
| A: no separation | | | | | | | | |
| Phase separation | | | | | | | | |
| top/bottom % | | | | | | | | |
| Emulsion stability | 1 hour | 31/69 | — | 23/77 | 52/48 | 35/65 | 28/72 | 22/78 |
| 30° C | 3 hours | — | — | — | — | — | — | — |
| A: no separation | | | | | | | | |
| Phase separation | | | | | | | | |
| top/bottom % | | | | | | | | |

| | | | | | | | |
|---|---|---|---|---|---|---|---|
| Emulsion stability result (A > B) | B | — | B | B | B | B | B |
| Cleaning Test | — | — | — | — | — | — | — |
| Appearance of initial samples | * | Partially | * | * | * | * | * |
| *Turbid Solution | | undissolved | | | | | |

| Ingredients | Structure | 81 | 82 | 83 | 84 | 85 | 86 | 87 |
|---|---|---|---|---|---|---|---|---|
| Octylamine | C8 amine | 73.0 | 60.0 | 50.0 | 40.0 | 60.0 | 60.0 | 60.0 |
| Ammonyx ® DO | Decylamine oxide | — | 25.0 | 25.0 | 25.0 | 20.0 | 20.0 | 25.0 |
| Cola ® Lux C-8 | Octyldimethylamine | 25.0 | — | — | — | — | — | — |
| | oxide | | | | | | | |
| Ammonyx ® MO | Myristyl | — | — | — | — | 5.00 | — | — |
| | dimethylamine oxide | | | | | | | |
| Ethox ® 4387 | C9-C11 ethoxylated | — | — | — | — | — | 8.00 | 8.00 |
| | alcohol + 6EO | | | | | | | |
| BYK ® 1780 | Blend of polyether- | 0.50 | 0.50 | 0.50 | 0.50 | 0.50 | 0.50 | 0.50 |
| | modified | | | | | | | |
| | polysiloxane with | | | | | | | |
| | hydrophobic particles | | | | | | | |
| SAG ® 47 | Modified poly- | 0.50 | 0.50 | 0.50 | 0.50 | 0.50 | 0.50 | 0.50 |
| | dimethylsiloxane | | | | | | | |
| Water | Water | 1.00 | 14.0 | 24.0 | 34.0 | 14.0 | 11.0 | 6.00 |
| Total (w/w %) | Total (w/w %) | 100.0 | 100.0 | 100.0 | 100.0 | 100.0 | 100.0 | 100.0 |
| Flashpoint | | — | — | — | — | — | — | — |
| Water content calculated (%) | | 16.0 | 21.6 | 41.5 | 51.5 | 31.5 | 25.0 | 23.5 |
| Persistent foam | Initial | — | — | — | — | — | — | — |
| after 1 min and | 54° C. for 2 weeks | — | — | — | — | — | — | — |
| 12 min (1/12) | | | | | | | | |
| Emulsion stability | 1 hour | 48/52 | — | — | — | — | A | A |
| A: no separation | 3 hours | 44/56 | — | — | — | — | A | A |
| Phase separation | | | | | | | | |
| top/bottom % | | | | | | | | |
| Emulsion stability | 1 hour | 25/75 | — | — | — | — | 58/42 | 87/13 |
| 30° C | 3 hours | — | — | — | — | — | 53/47 | 79/21 |
| A: no separation | | | | | | | | |
| Phase separation | | | | | | | | |
| top/bottom % | | | | | | | | |
| Emulsion stability result (A > B) | | | B | — | — | — | — | B |
| Cleaning Test | | — | — | — | — | — | — | — |
| Appearance of initial samples | | * | Gel | Gel | Gel | Gel | * | * |
| *Turbid Solution | | | | | | | | |
| Ingredients | Structure | 88 | 89 | 90 | 91 | 92 | 93 | 94 |
| Octylamine | C8 amine | 65.0 | 50.0 | 50.0 | 60.0 | 63.0 | 66.0 | 60.0 |
| Ammonyx ® DO | Decylamine oxide | 20.0 | 25.0 | 25.0 | 20.0 | 25.0 | 25.0 | 25.0 |
| Ammonyx ® MO | Myristyl | — | — | — | 5.00 | — | — | — |
| | dimethylamine oxide | | | | | | | |
| Ethox ® 4387 | C9-C11 ethoxylated | 8.00 | 8.00 | 12.0 | 8.00 | 8.00 | 8.00 | 10.0 |
| | alcohol + 6EO | | | | | | | |
| BYK ® 1780 | Blend of polyether- | 0.50 | 0.50 | 0.50 | 0.50 | 0.50 | 0.50 | 0.50 |
| | modified | | | | | | | |
| | polysiloxane with | | | | | | | |
| | hydrophobic particles | | | | | | | |
| SAG ® 47 | Modified poly- | 0.50 | 0.50 | 0.50 | 0.50 | 0.50 | 0.50 | 0.50 |
| | dimethylsiloxane | | | | | | | |
| Water | Water | 6.00 | 16.0 | 12.0 | 6.00 | 3.00 | 0.00 | 4.00 |
| Total (w/w %) | Total (w/w %) | 100.0 | 100.0 | 100.0 | 100.0 | 100.0 | 100.0 | 100.0 |
| Flashpoint | | — | — | — | — | — | — | — |
| Water content calculated (%) | | 20 | 33.5 | 29.5 | 23.5 | 20.5 | 17.5 | 21.5 |
| Persistent foam | Initial | — | — | — | — | — | — | — |
| after 1 min and | 54° C. for 2 weeks | — | — | — | — | — | — | — |
| 12 min (1/12) | | | | | | | | |
| Emulsion stability | 1 hour | A | — | — | A | A | A | A |
| Room Temp. | 3 hours | A | — | — | A | A | A | A |
| A: no separation | | | | | | | | |
| Phase separation | | | | | | | | |
| top/bottom % | | | | | | | | |
| Emulsion stability | 1 hour | 50/50 | — | — | 83/17 | 89/11 | 87/13 | 98/2 |
| 30° C | 3 hours | 49/51 | — | — | 72/28 | 79/21 | 72/28 | 93/7 |
| A: no separation | | | | | | | | |
| Phase separation | | | | | | | | |
| top/bottom % | | | | | | | | |

| | | | | | | | |
|---|---|---|---|---|---|---|---|
| Emulsion stability result (A > B) | B | B | — | — | B | B | B |
| Cleaning Test | — | — | — | — | — | — | — |
| Appearance of initial samples | * | Gel | Too | * | * | * | * |
| *Turbid Solution | | | Viscous | | | | |

| Ingredients | Structure | 95 | 96 | 97 | 98 | 99 |
|---|---|---|---|---|---|---|
| Octylamine | C8 amine | 60.0 | 62.0 | 60.0 | 60.0 | 60.0 |
| Ammonyx ® DO | Decylamine oxide | 26.0 | 26.0 | 20.0 | 17.5 | 17.0 |
| Ethox ® 4387 | C9-C11 ethoxylated | 10.0 | 9.00 | 15.0 | 17.5 | 17.0 |
| | alcohol + 6EO | | | | | |
| BYK ® 1780 | Blend of polyether- | 0.50 | 0.50 | 0.50 | 0.50 | 0.50 |
| | modified | | | | | |
| | polysiloxane with | | | | | |
| | hydrophobic particles | | | | | |
| SAG ® 47 | Modified poly- | 0.50 | 0.50 | 0.50 | 0.50 | 0.50 |
| | dimethylsiloxane | | | | | |
| Water | Water | 3.00 | 2.00 | 4.00 | 4.00 | 5.00 |
| Total (w/w %) | Total (w/w %) | 100.0 | 100.0 | 100.0 | 100.0 | 100.0 |
| Flashpoint | | — | — | >95° C. | >95° C. | >95° C. |
| Water content calculated (%) | | 21.2 | 20.2 | 18 | 16.25 | 16.9 |
| Persistent foam | Initial | — | — | 6/1 | 4/0 | 4/0 |
| after 1 min and | 54° C. for 2 weeks | — | — | 68/47 | 68/42 | 63/40 |
| 12 min (1/12) | | | | | | |
| Emulsion stability | 1 hour | A | A | A | A | A |
| Room Temp. | 3 hours | A | A | A | A | A |
| A: no separation | | | | | | |
| Phase separation | | | | | | |
| top/bottom % | | | | | | |
| Emulsion stability | 1 hour | 99/1 | 97/3 | 92/8 | 91/9 | 93/7 |
| 30° C | 3 hours | 91/9 | 92/8 | 86/14 | 87/13 | 80/20 |
| A: no separation | | | | | | |
| Phase separation | | | | | | |
| top/bottom % | | | | | | |

| | | | | | |
|---|---|---|---|---|---|
| Emulsion stability result (A > B) | A | A | A | A | A |
| Cleaning Test | — | — | good | — | — |
| Appearance of initial samples | * | * | * | * | * |
| *Turbid Solution | | | | | |

| Ingredients | Structure | 100 | 101 | 102 | 103 | 104 | 105 |
|---|---|---|---|---|---|---|---|
| Octylamine | C8 amine | 60.0 | 60.0 | 60.0 | 60.0 | 63.5 | 63.5 |
| Ammonyx ® DO | Decylamine oxide | 16.0 | 15.0 | 12.0 | 26.0 | 20.0 | |
| Ethox ® 4387 | C9-C11 ethoxylated | 16.0 | 15.0 | 18.0 | 11.0 | — | — |
| | alcohol + 6EO | | | | | | |
| Ethal ® LA-23 | C12-C14 | — | — | — | — | 15.0 | 25.0 |
| | Alcohol + 23EO | | | | | | |
| BYK ® 1780 | Blend of polyether- | 0.50 | 0.50 | 0.50 | 0.50 | 0.50 | 0.50 |
| | modified | | | | | | |
| | polysiloxane with | | | | | | |
| | hydrophobic particles | | | | | | |
| SAG ® 47 | Modified poly- | 0.50 | 0.50 | 0.50 | 0.50 | 1.00 | 1.00 |
| | dimethylsiloxane | | | | | | |
| Water | Water | 7.00 | 9.00 | 9.00 | 2.00 | 0.00 | 10.00 |
| Total (w/w %) | Total (w/w %) | 100.0 | 100.0 | 100.0 | 100.0 | 100.0 | 100.0 |
| Flashpoint | | — | — | — | >95° C. | >95° C. | >95° C. |
| Water content calculated (%) | | 18.2 | 19.5 | 17.4 | 20.2 | 18.5 | 16.3 |
| Persistent foam | Initial | — | — | — | 8/4 | — | — |
| after 1 min and | 54° C. for 2 weeks | — | — | — | 68/53 | 0/0 | 0/0 |
| 12 min (1/12) | | | | | | | |
| Emulsion stability | 1 hour | A | A | A | A | A | A |
| Room Temp. | 3 hours | A | A | A | A | A | A |
| A: no separation | | | | | | | |
| Phase separation | | | | | | | |
| top/bottom % | | | | | | | |
| Emulsion stability | 1 hour | 83/17 | 65/35 | 64/36 | A | A | 49/51 |
| 30° C | 3 hours | 67/33 | 58/42 | 54/46 | A | 97/3 | 46/54 |
| A: no separation | | | | | | | |
| Phase separation | | | | | | | |
| top/bottom % | | | | | | | |

| | | | | | | |
|---|---|---|---|---|---|---|
| Emulsion stability result (A > B) | B | B | B | A | A | B |
| Cleaning Test | — | — | — | good | Good | Bad |
| Appearance of initial samples | * | * | * | * | * | * |
| *Turbid Solution | | | | | | |

### Example 4. Cleaning Test

### Method

Synthetic rubber hoses were each filled with 290 ppm of a PPO inhibitor, a fraction of which is radiolabeled with a C-14 isotope as a tracer and each hose was capped on both ends. The capped hoses were stored for approximately 18 hours at room temperature. Following storage, the hoses were emptied and rinsed with water. In sets of two, hoses were then filled with a commercial cleaning solution or a composition from Table 3 including 53-55, 62, 64, 97 or 103, and re-capped. The hoses were then stored a second time for approximately 5 hours at room temperature. Following the second storage each hose was emptied, rinsed with water and then filled with a glyphosate composition and re-capped to simulate a subsequent use of agricultural equipment. After storage, glyphosate was removed from the hoses and analyzed for PPO inhibitor content using standard radiolabeling detection. Effectiveness of the cleaner was determined through the PPO inhibitor content in the glyphosate. Results of this experiment can be found in Table 4, below.

TABLE 4

| | Percent of Intact PPO |
|---|---|
| | inhibitor eluted with |
| Composition | glyphosate |
| Commercial Cleaner: Sodium | 96.4% |
| Hydroxide/Surfactant Cleaner | |
| (5x recommended use-rate) | |
| Commercial Cleaner: HDX Lemon Scent | 94.5% |
| Ammonia cleaner (50x recommended use-rate) | |
| Commercial Cleaner: HDX Lemon Scent | 94.4% |
| Ammonia cleaner (1x recommended use-rate) | |
| Composition 53 | 19.9% |
| Composition 54 | 18.1% |
| Composition 55 | 19.6% |
| Composition 62 | 21.7% |
| Composition 64 | 19.2% |
| Composition 97 | 20.5% |
| Composition 103 | 17.1% |

### Results

As seen in Table 4, above, the compositions 53-55, 62, 64, 97 and 103 containing an alkylamine degraded the intact PPO inhibitor such that only 17.1 to 21.7% of the intact PPO inhibitor was eluted with the glyphosate composition. This is in stark contrast to commercial cleaners each of which left behind more than 94% of the intact PPO inhibitor to be eluted by the glyphosate composition. Thus, amine compositions are capable of degrading PPO inhibitors in-situ in agricultural equipment.

### Example 5. Cleaning Test

### Method

PPO inhibitors were dissolved in methanol or acetonitrile (1.00 milliliters) to prepare a stock solution. To determine the ability of alkylamine cleaners to degrade these PPO inhibitors, 10 milliliters of an alkylamine composition was added to test vials. Then, 200 microliters of each PPO inhibitor stock solution was added to separate test vials and mixed thoroughly. To measure the concentration of the PPO inhibitor at different time points, the degradation process was stopped by reducing the pH with 10 drops of concentrated HCl (pH<2). Acetonitrile (10 milliliters) was then added and the test vials were shaken for 1 minute. Next, 4.5 grams of sodium sulfate and 2 grams of sodium chloride were added and the test vials were shaken for an additional 1 minute. The test vials were centrifuged and the top layer was analyzed for the concentration of the PPO inhibitor. The mixture was processed for analysis and the concentration of the PPO inhibitor was measured using standard high performance liquid chromatography as 0, 5, 30 and 120 minutes. Results of this experiment can be seen in Table 5, below.

TABLE 5

| | lactofen | | epyrifenacil | | flumioxazin | | butafenacil | |
|---|---|---|---|---|---|---|---|---|
| time | | % | | % | | % | | % |
| (min) | (ppm) | remaining | (ppm) | remaining | (ppm) | remaining | (ppm) | remaining |
| 0 | 226 | 100 | 214 | 100 | 204 | 100 | 193 | 100 |
| 5 | 148 | 66 | 29.1 | 14 | 55.1 | 27 | 123 | 64 |
| 30 | 26.6 | 12 | 11 | 5 | 42.3 | 21 | 41.2 | 21 |
| 120 | 5.83 | 3 | <1.15 | <1 | 23.1 | 11 | 20.3 | 11 |

As seen in Table 5, above, the composition containing amines degraded the intact PPO inhibitors. These amine compositions were capable of degrading PPO inhibitors even without the addition of an alkaline base (i.e. sodium hydroxide), a common herbicide commercial cleaner component. Thus, amine compositions are capable of degrading PPO inhibitors.

What is claimed is:

1. A composition comprising one or more alkylamines, one or more emulsifiers and one or more antifoaming agents.

2. The composition of claim 1, wherein the one or more alkylamines comprises from 6 to 10 carbon atoms.

3. The composition of claim 2, wherein the one or more alkylamines is octylamine.

4. The composition of claim 1, wherein the one or more emulsifiers is selected from decylamine oxide and one or more ethoxylated alcohols.

5. The composition of claim 4, wherein the one or more emulsifiers comprise one or more ethoxylated alcohols selected from the group consisting of ethoxylated alcohols comprising an alcohol comprising from 9 to 14 carbon atoms.

6. The composition of claim 5, wherein the one or more ethoxylated alcohols comprise an average of 6 to 23 moles of ethylene oxide.

7. The composition of claim 4, wherein the one or more emulsifiers comprise decylamine oxide and one or more ethoxylated alcohols.

8. The composition of claim 1, wherein the one or more antifoaming agents are selected from the group consisting of a silicone compound, a silicone emulsion, a polyether-modified dimethylsiloxane, a polydimethylsiloxane emulsion, a modified polydimethylsiloxane, a blend of polyether-modified polysiloxane with hydrophobic particles and octamethylcyclotetrasiloxane.

9. The composition of claim 1, further comprising at least about 10% w/w water, wherein w/w denotes weight by total weight of the composition.

10. The composition of claim 9, wherein the composition comprises at least about 12% w/w water.

11. The composition of claim 9, wherein the composition comprises from about 12% to about 50% w/w water.

12. A composition comprising an octylamine, decylamine oxide and one or more ethoxylated alcohols comprising an alcohol comprising from 9 to 14 carbon atoms an average of 6 to 23 moles of ethylene oxide.

13. The composition of claim 9 further comprising one or more antifoaming agents are selected from the group consisting of a silicone compound, a silicone emulsion, a polyether-modified dimethylsiloxane, a polydimethylsiloxane emulsion, a blend of polyether-modified polysiloxane with hydrophobic particles, octamethylcyclotetrasiloxane, and mixtures thereof.

14. A method of eluting protoporphyrinogen oxidase inhibitors from agricultural equipment comprising contacting the agricultural equipment with an effective amount of a composition of claim 1.

15. The method of claim 14, wherein the agricultural equipment comprises a hose or a line.

16. The method of claim 14, wherein the agricultural equipment comprises one or more materials selected from the group consisting of natural rubber, synthetic rubber, synthetic plastic polymers, polyurethane blends and polyethylene blends.

17. A method of degrading protoporphyrinogen oxidase (PPO) inhibitors comprising contacting the PPO inhibitors with an effective amount of a composition of claim 1.

18. The method of claim 17, wherein the PPO inhibitors are in contact with agricultural equipment prior to and during contact with the composition comprising one or more amines.

19. The method of claim 17, wherein the agricultural equipment comprises a hose or a line.

20. The method of claim 17, wherein the agricultural equipment comprises one or more materials selected from the group consisting of natural rubber, synthetic rubber, synthetic plastic polymers, polyurethane blends and polyethylene blends.
